(19) United States
(12) Patent Application Publication
(10) Pub. No.: US 2026/0234859 A1
(43) Pub. Date: Aug. 13, 2026

(54) DOOR ASSEMBLY FOR A LAUNDRY APPLIANCE

(71) Applicant: Haier US Appliance Solutions, Inc., Wilmington, DE (US)

(72) Inventors: Venkata Chakradhar Rangu, Louisville, KY (US); Christopher Gene Vowels, Cox's Creek, KY (US); Jordan Kyle Weidner, Louisville, KY (US)

(21) Appl. No.: 19/051,246

(22) Filed: Feb. 12, 2025

(51) Int. Cl. D06F 39/14; C09J 7/26; D06F 23/02; D06F 58/02; D06F 58/20

(52) U.S. Cl. CPC D06F 39/14; C09J 7/26; D06F 23/02; D06F 58/02; D06F 58/20; C09J 2301/124; C09J 2400/243

(57) ABSTRACT

A laundry appliance defining includes a tub positioned within a cabinet, a basket rotatably mounted within the tub and defining a chamber for receiving of a load of clothes, and a door assembly rotatably mounted to the cabinet to provide selective access to the chamber. The door assembly an outer door frame, a double-sided tape positioned on the outer door frame, and a door vent positioned on the double-sided tape to secure the door vent to the outer door frame.

### FIELD OF THE INVENTION

The present subject matter relates generally to laundry appliances, or more specifically, to door assemblies of laundry appliances.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Conventional washing machine appliances (or laundry appliances in general) include a door that is pivotally mounted to the cabinet over a front opening to provide selective access to the wash chamber. Typical laundry appliances include door assemblies that are constructed from a plurality of components that are joined together. However, relative movement between these various components may result in a lower quality feel to the door. In addition, relative movement between door components may result in an audible squeaking or rubbing sound that is disturbing to the consumer. Conventional means for addressing this relative movement between components include the use of costly and complex components, increase assembly time, and often result in assembly errors that require corrective maintenance.

Accordingly, a laundry appliance having an improved door would be desirable. More specifically, an appliance door that is easy to assemble while providing improved rigidity and reduced relative movement between door components would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a laundry appliance defining a vertical direction, a lateral direction, and a transverse direction is provided, including a tub positioned within a cabinet, a basket rotatably mounted within the tub and defining a chamber for receiving of a load of clothes, and a door assembly rotatably mounted to the cabinet to provide selective access to the chamber. The door assembly includes an outer door frame, a double-sided tape positioned on the outer door frame, and a door vent positioned on the double-sided tape to secure the door vent to the outer door frame.

In another exemplary embodiment, a door assembly for a laundry appliance is provided. The laundry appliance defines a vertical direction, a lateral direction, and a transverse direction, the laundry appliance including a tub positioned within a cabinet and a basket rotatably mounted within the tub and defining a chamber for receiving of a load of clothes. The door assembly includes an outer door frame, a double-sided tape positioned on the outer door frame, and a door vent positioned on the double-sided tape to secure the door vent to the outer door frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter.

FIG. 2 provides a front view of the example washing machine appliance of FIG. 1 with a door assembly in the open position according to an example embodiment of the present subject matter.

FIG. 3 provides a side cross-sectional view of the example washing machine appliance of FIG. 1 according to an example embodiment of the present subject matter.

FIG. 4 provides an exploded view of the example door assembly of FIG. 2 according to an example embodiment of the present subject matter.

FIG. 5 provides a front view of the example door assembly of FIG. 2 including a door vent according to an example embodiment of the present subject matter.

FIG. 6 provides a rear view of the example door assembly of FIG. 2 according to an example embodiment of the present subject matter.

FIG. 7 provides a close-up, cross-sectional view of the example door assembly of FIG. 2 according to an example embodiment of the present subject matter.

FIG. 8 provides a rear perspective view of the example door vent of FIG. 5 according to an example embodiment of the present subject matter.

FIG. 9 provides an exploded view of a door assembly and a door vent according to another example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to a double-sided tape or a pre-applied double-sided tape that is used to attach a chrome vent to an outer door frame of a front load laundry appliance, e.g., a washer, dryer, or combination washer/dryer unit. For example, the tape may be applied to the chrome vent and then the chrome vent may be positioned onto the outer door of the front load laundry appliance. According to another example embodiment, the double-sided tape vent may be pre-applied to the chrome vent and attached to the front load laundry appliance outer door as desired.

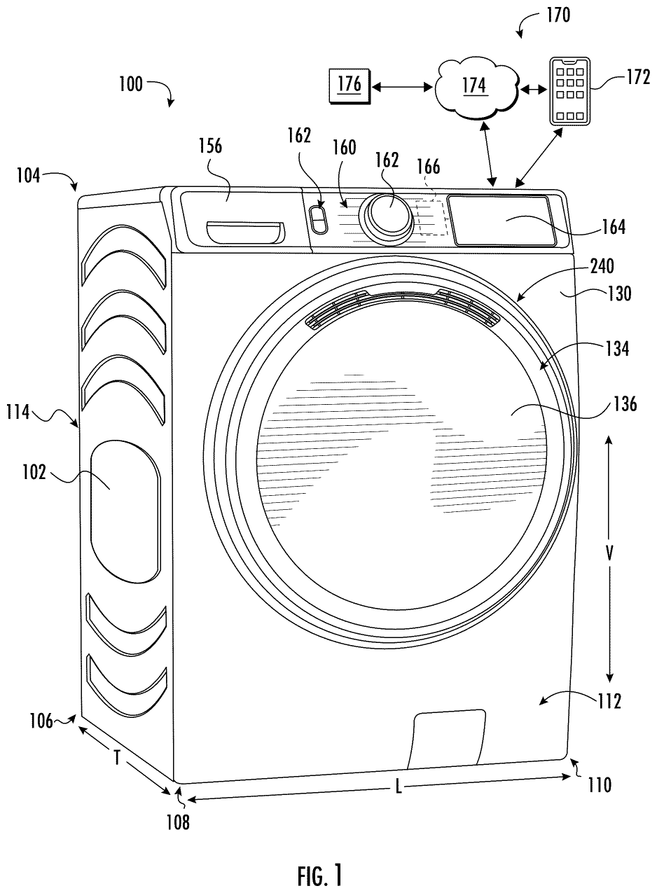

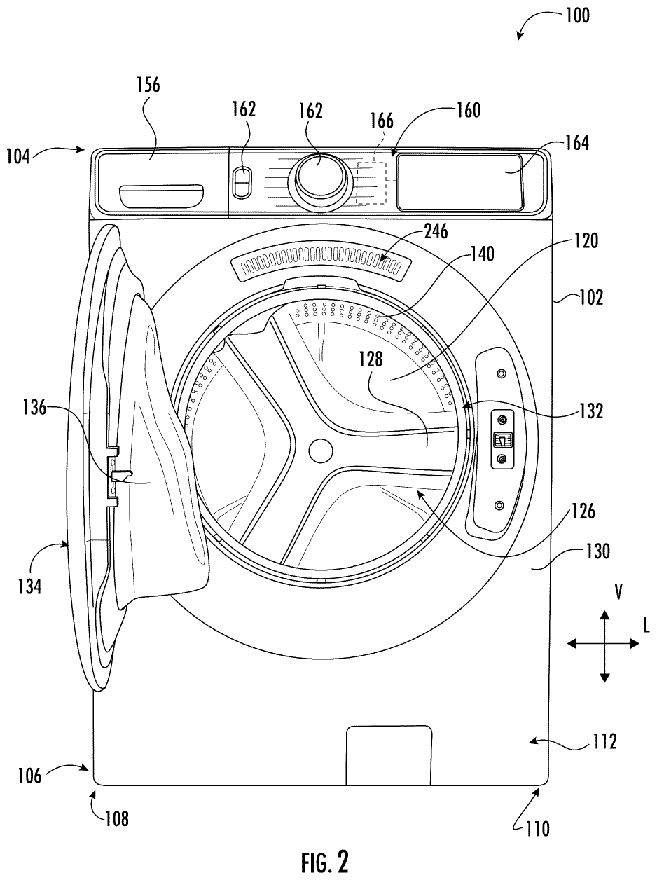

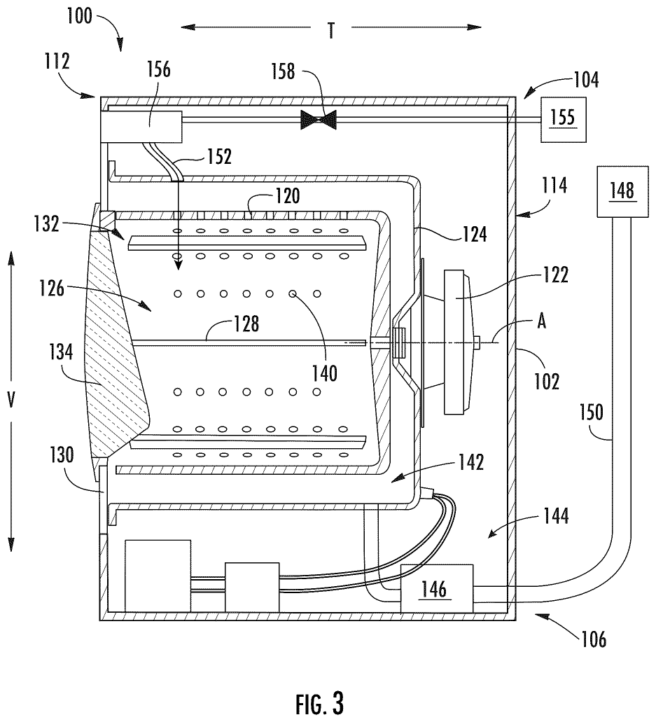

Referring now to the figures, FIG. 1 is a perspective view of an exemplary horizontal axis washing machine appliance 100, FIG. 2 is a front view of washing machine appliance 100, and FIG. 3 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIGS. 2 and 3, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 3, a plurality of ribs 128 extends from basket 120 into wash chamber 126. In this manner, for example, ribs 128 may lift articles disposed in wash basket 120 during rotation of wash basket 120.

Referring generally to FIGS. 1 through 3, cabinet 102 also includes a front panel 130 which defines a chamber opening 132 that permits user access to wash basket 120 of wash tub 124. More specifically, washing machine appliance 100 includes a door 134 that is positioned over chamber opening 132 and is rotatably mounted to front panel 130. In this manner, door 134 permits selective access to chamber opening 132 by being movable between an open position (FIG. 2) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not labeled) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 3, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout (such as supply conduit 152) may be configured for directing a flow of fluid into wash tub 124. For example, supply conduit 152 may be in fluid communication with a water supply 154 (FIG. 3) in order to direct fluid (e.g., clean water or wash fluid) into wash tub 124. Supply conduit 152 may also be in fluid communication with the sump 142. For example, pump assembly 144 may direct wash fluid disposed in sump 142 to supply conduit 152 in order to circulate wash fluid in wash tub 124.

As illustrated in FIG. 3, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to supply conduit 152 to facilitate the complete and accurate dispensing of wash additive.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through chamber opening 132, and washing operation is initiated through operator manipulation of input selectors 162. Wash tub 124 is filled with water, detergent, and/or other fluid additives, e.g., via supply conduit 152 and or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through chamber opening 132.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Referring still to FIG. 1, a schematic diagram of an external communication system 170 will be described according to an exemplary embodiment of the present subject matter. In general, external communication system 170 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 170 may be used to transfer data or other information to improve performance of one or more external devices or appliances and/or improve user interaction with such devices.

For example, external communication system 170 permits controller 166 of washing machine appliance 100 to communicate with a separate device external to washing machine appliance 100, referred to generally herein as an external device 172. As described in more detail below, these communications may be facilitated using a wired or wireless connection, such as via a network 174. In general, external device 172 may be any suitable device separate from washing machine appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with washing machine appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control washing machine appliance 100, etc. In addition, external device 172 and remote server 176 may communicate with washing machine appliance 100 to communicate similar information.

In general, communication between washing machine appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with washing machine appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

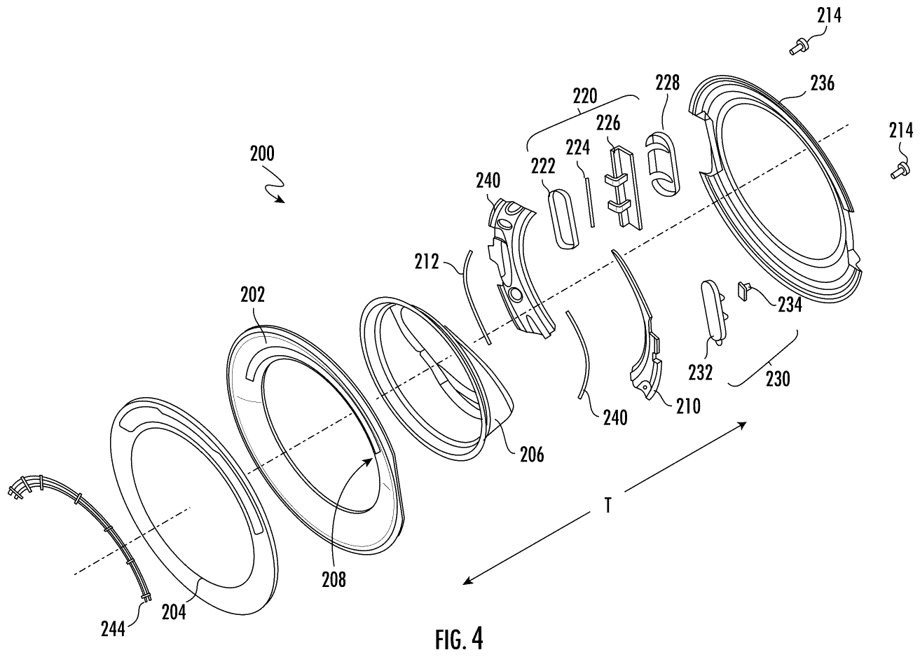

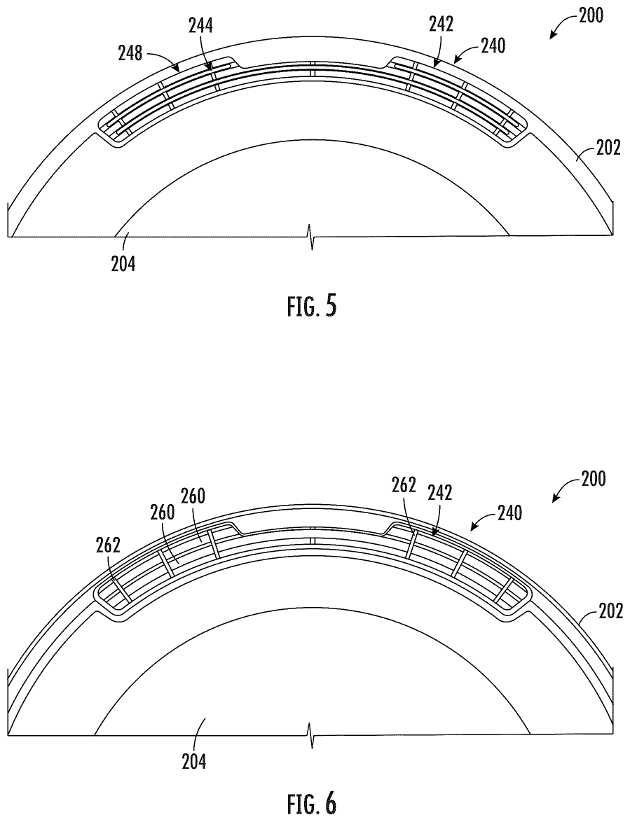

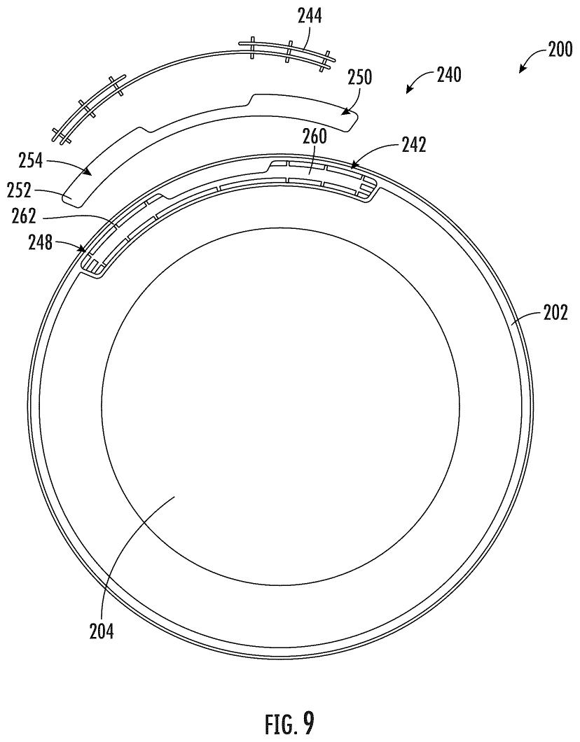

Referring now also generally to FIGS. 4 through 9, a door assembly 200 that may be used with washing machine appliance 100 will be described according to example embodiments of the present subject matter. In this regard, door assembly 200 may be the same as or replace door 134 as described above. In addition, although door assembly 200 is described herein as being used with washing machine appliance 100, it should be appreciated that door assembly 200 may be used on any other suitable laundry appliance, e.g., such as a dryer appliance, a combination washer/dryer appliance, or any other suitable appliance to provide selective access to an interior chamber through a front opening. Although an exemplary construction of door assembly 200 is described herein, it should be appreciated that variations and modifications may be made to the door assembly 200 while remaining within the scope of the present subject matter.

As shown in the exploded view of FIG. 4, the door assembly 200 may generally include various components that are stacked along the transverse direction T. It should be appreciated that the directional orientation used to describe door assembly 200 may be similar to that used to describe the washing machine appliance 100, assuming door assembly 200 is in the closed position. Door assembly 200 may include an outer door frame 202 on which to an outer window 204 may be seated to provide a front appearance piece and contact area for door assembly 200. In addition, a glass door bowl 206 may be seated within a central aperture 208 of outer door frame 202.

As will be described in more detail below, one or more reinforcement brackets 210 may be mounted to or attached to outer door frame 202 to secure glass bowl 206 to door frame 202 and to provide structural support for other attachment features of door assembly 200. According to the illustrated embodiment, door assembly 200 may include two reinforcement brackets 210, though the number, configuration, and positioning of reinforcement bracket(s) 210 may vary while remaining within the scope of the present subject matter.

As illustrated, door assembly 200 may further include one or more vibration isolators 212 that are positioned between glass bowl 206 and reinforcement brackets 210. In addition, outer door frame 202 may define one or more bosses, reinforcement bracket 210 may define one or more apertures, and one or more fasteners 214 may pass through the apertures and may be secured within the more bosses to secure outer door frame 202 to reinforcement bracket 210. According to an example embodiment, door bowl 206 is formed from glass and reinforcement bracket 210 is formed from metal or rigid, injection molded plastic.

According to the illustrated embodiment, the door assembly 200 may further include a hinge assembly 220 that is designed to attach door assembly 200 to the front panel 130 of cabinet 102. Hinge assembly 220 may generally be designed to support one side of door assembly 200 and permit rotation about a vertical axis to facilitate selective access to wash chamber 126 through chamber opening 132. For example, according to the illustrated embodiment, hinge assembly 220 may generally include a hinge bracket 222 that is mounted to reinforcement bracket 210 as described in more detail below. A hinge pin 224 may rotatably couple hinge bracket 222 to a door hinge 226. In addition, a hinge bracket cover 228 may be positioned over hinge bracket 222 to prevent pinching and conceal working components of hinge assembly 220.

In addition, door assembly 200 may include a handle assembly 230 that a user may grasp to open and close door assembly 200. Handle assembly 230 may also be used to secure or lock door assembly 200 in the closed position. For example, handle assembly 230 may generally include a handle body 232 that attaches to reinforcement bracket 210 on an opposite lateral side of the door assembly 200 relative to hinge assembly 220. A striker 234 may be mounted within or attached to handle body 232 for engaging a latching or locking mechanism positioned within front panel 130 of cabinet 102. In addition, door assembly 200 may include an inner door panel 236 that mounts to outer door frame 202 and conceals various components of door assembly 200.

As explained above, conventional door assemblies are constructed from a plurality of components that are joined together. However, relative movement between these various components may result in a lower quality feel to the door. In addition, relative movement between door components may result in an audible squeaking or rubbing sound that is disturbing to the consumer. Conventional means for addressing this relative movement between components include the use of costly and complex components, increase assembly time, and often result in assembly errors that require corrective maintenance. Accordingly, aspects of the present subject matter are generally directed to features for simplifying assembly of a laundry appliance door assembly, improving the feel and quality of the door assembly, and reducing overall costs of the door assembly.

In this regard, referring generally to FIGS. 4 through 9, door assembly 200 may include a vent assembly 240 that is generally configured to permit a flow of fresh air into wash chamber 126, e.g., to reduce moisture levels, reduce mold/mildew formation, dry clothes, etc. In this regard, for example, vent assembly 240 may include a vent aperture 242 that is defined through outer door frame 202 and a door vent 244 that is mounted over vent aperture 242. In this regard, for example, vent aperture 242 may be defined through door assembly 200 and may be fluidly coupled to an internal vent 246 (see FIG. 2) for passing fresh air into wash chamber 126. Although an example vent aperture 242 is illustrated herein, it should be appreciated that the size, geometry, and position of vent aperture 242 may vary while remaining within the scope of the present subject matter. For example, vent aperture 242 and door vent 244 are illustrated as being positioned proximate a top of door assembly 200 and extending in an arcuate manner around a perimeter of outer door frame 202, though other configurations are possible.

In general, door vent 244 may be formed from any suitably rigid material and may be coated or plated for improved appearance, cleanability, etc. For example, door vent 244 may be formed by injection molding, e.g., using a suitable plastic material, such as injection molding grade Polybutylene Terephthalate (PBT), Nylon 6, high impact polystyrene (HIPS), acrylonitrile butadiene styrene (ABS), or any other suitable blend of polymers. Alternatively, according to the exemplary embodiment, these components may be compression molded, e.g., using sheet molding compound (SMC) thermoset plastic or other thermoplastics. According to still other embodiments, door vent 244 may be formed from any other suitable rigid material, such as metal. In addition, door vent 244 may be coated or plated in chrome or another suitable finish material.

According to the illustrated embodiment, door vent 244 is defined at a bottom of a recess 248 that is defined within outer door frame 202. In this regard, door vent 244 may be seated within recess 248 over vent aperture 242. Notably, door vents or covers are typically joined to door frames using mechanical snaps or fasteners, which may result in undesirable movement or squeaking during operation of door assembly 200 or washing machine appliance 100. Accordingly, aspects of the present subject matter are directed to features for mounting door vent 244 in a manner that reduces relative movement of components, minimizes squeaking, simplifies assembly, and results in a door assembly 200 having a higher quality look and feel.

Specifically, according to an example embodiment, vent assembly 240 may include double-sided tape 250 that is used to secure door vent 244 to outer door frame 202. In this regard, for example, double-sided tape 250 may be placed on a back side of door vent 244 or within recess 248 prior to positioning door vent 244 into the installed position within recess 248. Specifically, double-sided tape 250 may be positioned on door vent 244 prior to mounting door vent 244 onto outer door frame 202. Alternatively, double-sided tape 250 may be positioned on outer door frame 202 prior to mounting door vent 244.

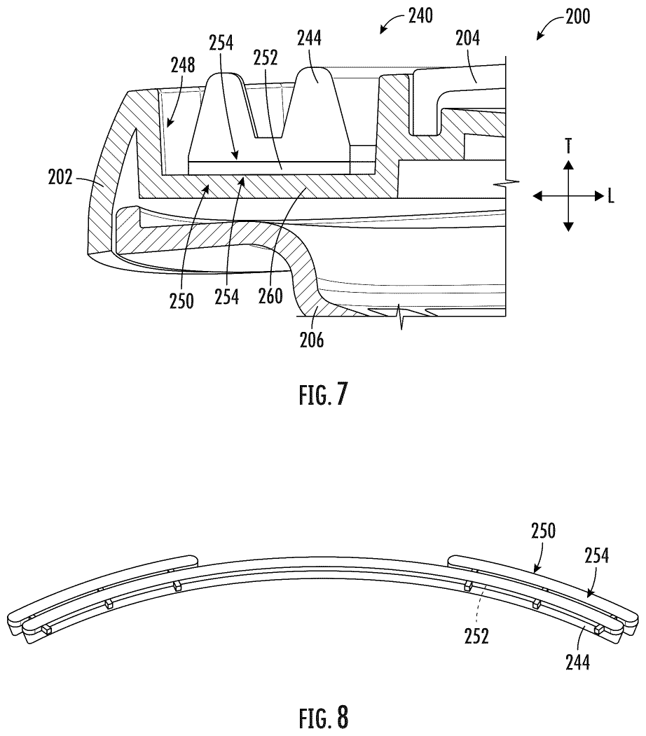

According to an example embodiment best illustrated in FIG. 7, double-sided tape 250 may generally include a foam core 252 and adhesive layers 254 positioned on opposite sides of foam core 252. Adhesive layers 254 may be covered by a removable liner that the installation technician may peel off prior to installing door vent 244. In general, foam core 252 may be slightly compressible and may have a thickness such that door vent 244 sits flush with a front surface of outer door frame 202 when double-sided tape 250 and door vent 244 are installed within recess 248.

In general, outer door frame 202 may define features for supporting door vent 244 without overly restricting the flow of air through vent aperture 242. In this regard, for example, outer door frame 202 may define a tape bed 260 positioned within vent aperture 242 for supporting door vent 244 over vent aperture 242. For example, as illustrated in FIG. 6, tape bed 260 may include two arcs that are supported by radially extending support bars 262. According to an alternative embodiment illustrated in FIG. 9, tape bed 260 may include a single, thicker, arcuate tape bed 260 suspended within a middle of vent aperture 242 using support bars 262. Other support structures are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance defining a vertical direction, a lateral direction, and a transverse direction, the laundry appliance comprising:
a tub positioned within a cabinet;
a basket rotatably mounted within the tub and defining a chamber for receiving of a load of clothes; and
a door assembly rotatably mounted to the cabinet to provide selective access to the chamber, the door assembly comprising:
an outer door frame;
a double-sided tape positioned on the outer door frame; and
a door vent positioned on the double-sided tape to secure the door vent to the outer door frame.

2. The laundry appliance of claim 1, wherein the outer door frame defines a recess for receiving the double-sided tape and the door vent.

3. The laundry appliance of claim 2, wherein the door vent sits flush with a front surface of the outer door frame when the double-sided tape and the door vent are installed within the recess.

4. The laundry appliance of claim 2, wherein the outer door frame defines a vent aperture within the recess, the outer door frame further comprising:
a tape bed positioned within the vent aperture for supporting the door vent over the vent aperture.

5. The laundry appliance of claim 4, wherein the tape bed is arcuate and is suspended within the vent aperture by a plurality of support bars.

6. The laundry appliance of claim 1, wherein the door vent is formed from injection molded plastic and is chrome-plated.

7. The laundry appliance of claim 1, wherein the double-sided tape is positioned on the door vent prior to mounting the door vent onto the outer door frame.

8. The laundry appliance of claim 1, wherein the double-sided tape is positioned on the outer door frame prior to mounting the door vent.

9. The laundry appliance of claim 1, wherein the double-sided tape comprises:
a foam core and adhesive layers positioned on opposite sides of the foam core.

10. The laundry appliance of claim 1, wherein the door vent is positioned proximate a top of the door assembly.

11. The laundry appliance of claim 1, wherein the laundry appliance is a front load washing machine appliance or a front load dryer appliance.

12. A door assembly for a laundry appliance, the laundry appliance defining a vertical direction, a lateral direction, and a transverse direction, the laundry appliance comprising a tub positioned within a cabinet and a basket rotatably mounted within the tub and defining a chamber for receiving of a load of clothes, the door assembly comprising:
an outer door frame;
a double-sided tape positioned on the outer door frame; and
a door vent positioned on the double-sided tape to secure the door vent to the outer door frame.

13. The door assembly of claim 12, wherein the outer door frame defines a recess for receiving the double-sided tape and the door vent.

14. The door assembly of claim 13, wherein the door vent sits flush with a front surface of the outer door frame when the double-sided tape and the door vent are installed within the recess.

15. The door assembly of claim 13, wherein the outer door frame defines a vent aperture within the recess, the outer door frame further comprising:
a tape bed positioned within the vent aperture for supporting the door vent over the vent aperture.

16. The door assembly of claim 15, wherein the tape bed is arcuate and is suspended within the vent aperture by a plurality of support bars.

17. The door assembly of claim 12, wherein the door vent is formed from injection molded plastic and is chrome-plated.

18. The door assembly of claim 12, wherein the double-sided tape is positioned on the door vent prior to mounting the door vent onto the outer door frame.

19. The door assembly of claim 12, wherein the double-sided tape is positioned on the outer door frame prior to mounting the door vent.

20. The door assembly of claim 12, wherein the double-sided tape comprises:
a foam core and adhesive layers positioned on opposite sides of the foam core.
